(19) United States
(12) Patent Application Publication
(10) Pub. No.: US 2007/0225935 A1
(43) Pub. Date: Sep. 27, 2007

(54) Controlling an Electronic Device

(76) Inventors: Sami Ronkainen, Oulu (FI); Juha P. Matero, Oulu (FI)

Correspondence Address: Hollingsworth & Funk, 8009 34th Avenue South, Suite 125, Minneapolis, MN, 55425, US

(21) Appl. No.: 11/597,883

(22) PCT Filed: Jun. 22, 2005
(86) PCT No.: PCT/FI05/50226

§ 371 Date: Nov. 29, 2006

(30) Foreign Application Priority Data
Jun. 24, 2004 (FI) 20045239

(51) Int. Cl. G06F 3/00

(52) U.S. Cl. 702/150

(57) ABSTRACT

An electronic device (500) comprising means (510) for identifying a motion pattern in a motion of the device, and means (510) for eliminating the effect of the motion pattern from a control motion employed for controlling the device. The identification unit (510) eliminates the effect of an identified motion pattern from the control motion by comparing the motion information measured by the measurement unit (508) with the control motion stored in the memory (504).

### BACKGROUND OF THE INVENTION

The invention relates to identifying movement in a mobile environment and particularly to utilizing the identified movement in controlling a device.

Several different manners of controlling an electronic device, such as a mobile telephone, have been developed. Alongside with keyboard-based control, control methods include those wherein the control is based on voice and gestures, for example. In a prior art device, the display can be implemented in such a manner that, irrespective of changes in the orientation of the device, the text of the display can always be read vertically. It is also known to zoom the display by turning the device. Solutions based on acceleration sensors have also been utilized for instance for replacing the keyboard of a computer in such a manner that a given finger position is associated with a given character input.

Said prior art applications are associated with the significant drawback that the control does not take into consideration the environment or the operating situation wherein the device is being used or identification is being performed. For this reason, should any essential motion-based disturbing factors be associated with the environment or operating situation, the risk of misrecognitions is apparent and substantially compromises the usability of the device.

### BRIEF DESCRIPTION OF THE INVENTION

The object of the invention is thus to provide an improved method and an apparatus for implementing the method in a manner that better takes into consideration the operating situation and/or environment of the device. Accordingly, the object of the invention is a method of controlling an electronic device, comprising identifying a motion pattern in the motion of the device and eliminating the effect of the identified motion pattern from a control motion used for controlling the device.

The invention also relates to a software product comprising a software routine for receiving measurement information descriptive of a motion of the device, a software routine for identifying a motion pattern in the measurement information, and a software routine for eliminating the effect of the identified motion pattern from a control motion used for controlling the device and included in the measurement information.

The invention also relates to an electronic device comprising means for identifying a motion pattern in a motion of the device, and means for eliminating the effect of the identified motion pattern from a control motion used for controlling the device.

Preferred embodiments of the invention are described in the dependent claims.

The invention is based on aiming at identifying, in an electronic device, whether the device is susceptible to an identifiable motion pattern. An identifiable motion pattern may be directed to an electronic device for instance when the device is subjected to mechanical vibration. Herein, mechanical vibration refers to a recurring motion directed to the device when the device is in a train or a car, for example. In association with the description of the invention, an identifiable motion pattern may also refer to a motion pattern corresponding to the walk of a person carrying the device, for example.

In accordance with the invention, the motion pattern is identified and its effect is eliminated from the device control motion. The control motion is a gesture, such as a turn or a swing of the device, for example. The control motion may also be a tap on the device, for example.

The device according to the invention may be e.g. a mobile telephone, a portable computer or another corresponding device enabling motion identification.

An advantage of the method and device of the invention is that the control motions intended to control the device can be identified considerably better and with fewer erroneous identifications once an identified disturbance is eliminated from the control motions.

### BRIEF DESCRIPTION OF THE FIGURES

In the following, the invention will be described in more detail in connection with preferred embodiments with reference to the accompanying drawings, in which

FIG. 1 shows an embodiment of the method of the invention;

FIG. 2 illustrates the identification of a motion pattern according to an embodiment;

FIG. 3 illustrates the identification of a motion pattern according to an embodiment;

FIG. 4 illustrates a measurement signal filtered from a known motion pattern;

FIG. 5 shows an electronic device according to an embodiment as a block diagram.

### DETAILED DESCRIPTION OF THE INVENTION

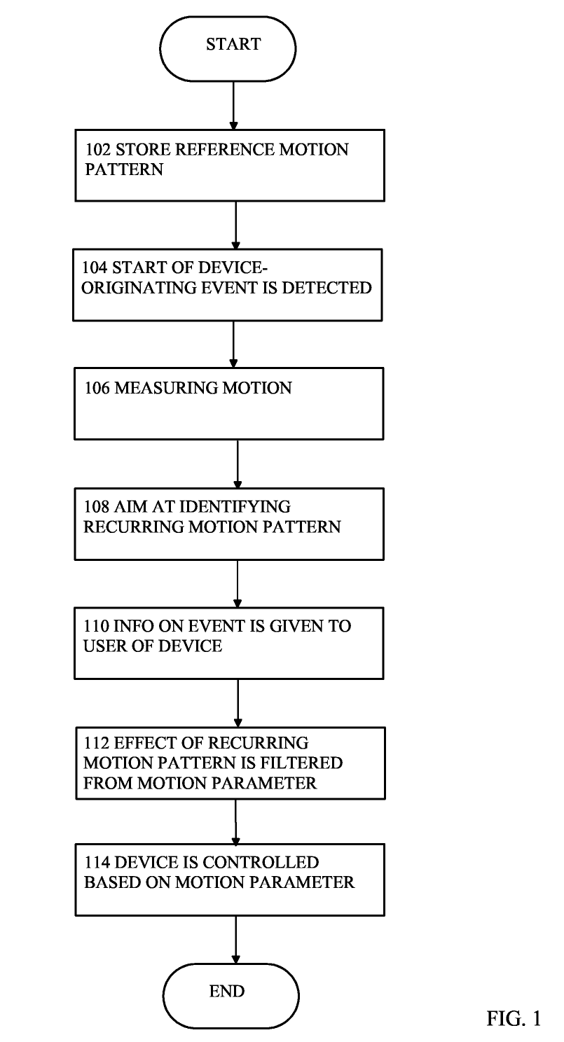

In the following, an embodiment of the method according to the invention will be described by means of FIG. 1. In the initial step 102 of the method, a given reference motion pattern is stored in an electronic device. The reference motion pattern can be stored in the device for instance at the factory in connection with the manufacture of the device. The stored reference motion patterns may describe the operating environment of the device, for instance that the device is in a train or carried by a person riding a bicycle. The patterns stored in the device as a factory setting may be based for instance on a large number of operating situation examples, from which an average motion pattern is generated. Alternatively, the device may comprise several alternative patterns for a given operating environment, such as a train.

In addition to the reference motion patterns stored as a factory setting, the user may teach the device the desired patterns. For example, the user may teach the device a reference motion pattern corresponding to his walk by depressing a given key at the start and the end of the teaching. The device stores the data between the keystrokes and analyses it by searching the data for acceleration signal values recurring in a certain manner, for example.

Generally, it is advantageous to keep the motion measurement, which consumes much energy, switched off in an electronic device, such as a mobile telephone. For example, conditions may be set in the device as to when motion measurement is activated. As regards the condition to be checked, two different operating situations can be distinguished, device-originating and user-originating operating situations. The device-originating operating situation according to step 104 refers to an operating situation wherein the device is aware of the event before the user is. For example, in the case of a mobile telephone, a device-terminating call is an example of a device-originating event. The mobile telephone is aware of the incoming call based on the signalling preceding the call, and is thus able to detect the start of the device-originating event on the basis of the start of said signalling. Other examples of device-originating events that can be brought forward include for instance a short message arriving at the mobile telephone or a timer triggering off, e.g. an alarm clock or a calendar alarm in an electronic device.

A user-originating operating situation refers to an event originating from the user. In a user-originating operating situation, the device may deduce the start of the use of the device on the basis of a given initial impulse, for example. Herein, an initial impulse refers to a function by means of which the device is able to conclude the start of the use. As an example of an initial impulse, opening of the keypad lock may be mentioned. FIG. 1 shows an embodiment of a device-originating event, but it can also be applied to a user-originating event with the exception of steps 104 and 110.

In an embodiment, the start of a device-originating or user-originating situation initiates motion measurement in the device in accordance with step 106.

Although conditions may be set on motion measurement, continuous motion status measurement in the device is also feasible. For example, in a user-originating situation, the device may operate such that the device continuously aims at identifying gestures by comparing a measured motion with the threshold values of one or more gestures. The device may also tape its motion in a memory for a given time, such as for the duration of 10 seconds, for example. If uncertainty exists at a given point in time whether the user performed a gesture, the taped data may be reverted to and attempts may be made to identity the motion pattern in the data. This may improve the gesture identification performed at said point in time, once the identified motion pattern can be filtered off. Motion status measurement can also be performed periodically in the device. As an example may be mentioned recurring signalling, based on location determination, for example, between a mobile telephone and a network, allowing the motion status to be measured always when the device has to be activated also otherwise because of the signalling.

Step 106 describes motion measurement in an electronic device. Motion may be measured by means of one or more motion parameters, such as an acceleration parameter, for example. Acceleration measurement may be performed for instance in three mutually perpendicular linear directions: directions x, y and z. In addition to acceleration measurement in said linear directions, angular acceleration may also be measured in the device by means of a magnetometer or a gyroscope, for example.

In step 108, an attempt is made to identify a motion pattern possibly detectable in the motion of the device. In principle, the motion pattern may be identified in two different manners, either by comparing the motion with a previously stored/taught reference motion pattern or by aiming at identifying some new motion pattern in the data measured.

Attempts may be made to identify a motion pattern motion parameter-specifically for instance by studying the x-oriented linear component and the y-oriented linear component separately. In identifying a motion pattern, several motion parameters may also be studied together as a whole. In this case, the sum vector composed of the acceleration components can be compared with a predetermined threshold value. In the case of a three-dimensional vector, the orientation of the device may be checked from time to time and, if necessary, take it into consideration when amending the direction of the sum vector.

When the motion parameter measured is compared with a previously stored reference motion pattern, the comparison can be carried out for a given predetermined period of time. If the correlation between the motion parameter and the reference pattern is sufficiently high during the period of time measured, it may be stated that the reference motion pattern was found in the motion parameter. In a preferred embodiment, a recurring motion pattern, i.e. periodicity in a signal, is identified in the measured signal by means of an autocorrelation function. Autocorrelation indicates the correlation between the signal values and the previous values, i.e. in that case, there is no need to utilize previously stored reference motion patterns or usage context data in the identification of the motion pattern.

In the identification of a new motion pattern, the procedure may be for instance such that a reference sample of a given length is taken from the signal to be measured, such as a z acceleration signal. The sampling can be timed for instance at such a point of the signal when the signal distinctly deviates from the basic level indicating immobility. The reference sample taken can then be slid over the z signal to be measured, and if the reference sample corresponds with some predetermined accuracy to a later signal sample, the conclusion is that the motion pattern has recurred. It is evident that threshold conditions can be set on the recurrence of the motion pattern, such as that the detected pattern recurs sufficiently often and that the congruity of the pattern in respect of the measured data is sufficiently significant, for example. Once the motion pattern is found, attempts can still be made separately to identify the length and correct position in the time domain of the pattern. This refers to the fact that at the initial stage, the reference sample did not necessarily hit the right position in the time domain, but was in the middle of changes occurring in the signal, for example. Once the correct position and length in the time domain are found for the reference sample, the sample can be employed in correcting a measured motion parameter.

In a preferred embodiment, attention is also paid in the device to the fact that the duration in time and amplitude of the motion pattern may change slidingly in time. The motion pattern may also be visible in the device different when the device is in the pocket or the hand, for example.

Furthermore, other irregularities in a recurring motion pattern, detected at given points in time, may be taken into account in the device. For example, even if no periodicity were detected in the signal at a given point in time, it does not necessarily mean that periodicity has disappeared from the signal. In other words, a threshold condition, which may be a given time threshold value, for example, may be set on the disappearance of periodicity. In this case, if periodicity is not detected during a period of time longer than the threshold value, it may be concluded to have disappeared.

In method step 110, once the motion pattern is measured, information on the event is given to the user of the device in a device-originating operating situation.

In method step 112, the effect of the identified motion pattern on one or more motion parameters is corrected. In an embodiment, a signal according to the measured motion pattern is directly subtracted from the measured motion parameter in order to obtain a corrected motion parameter value. According to another embodiment, threshold values employed for general motion identification are adjusted in the device. For example, if a mobile telephone allows an incoming call to be answered, i.e. the device can be controlled by a swinging gesture of the magnitude of threshold value ‘k’, the threshold value may be raised to level ‘1.3*k’, for example, during an identified motion pattern, the new level being employed for controlling the device in the manner illustrated by step 114. The gestures employed for controlling the device may be stored in the device in advance or the user himself may teach the device the desired control gestures, which may be e.g. turns, swings, tilts, taps or the like. In association with teaching or storage, a given threshold value set of acceleration signal values during a given period of time, for example, is generated for each gesture. Later, a gesture may be detected in the device such that one or more acceleration signals measured fulfil the threshold condition determined for it in advance. Herein, a threshold condition refers to a series of acceleration component values in a given order and during a given time, for example. At the identification stage, the order and/or time limits may be interpreted more strictly or loosely depending on whether the intention is to emphasize that the system does not accidentally interpret some user motions unintentionally as gestures or that the device will not erroneously fail to identify the correct gestures performed by the user. In a preferred embodiment, when the device detects that the user is performing a gesture, the device aims at separately identifying the periodicity associated with the gesture. There is no need to eliminate such gesture-related periodicity. An example of gesture-related periodicity is that if the gesture performed by the user is a tap, the mechanics of the device may remain vibrating for a moment, wherefore a gesture-related periodic component is visible in the motion of the device.

In a preferred embodiment, the device aims at identifying a change occurring in an identified motion pattern at the beginning of a control motion. In other words, for example, if the user of a mobile telephone is in a car, the device is subjected to mechanical vibration as a motion pattern. If a call is incoming to the mobile telephone, the device measures the mechanical vibration before issuing an alarm to the user. At the instant of the alarm, if the mobile telephone is in a pocket, for example, the device is momentarily subjected to a different acceleration than previously when the user takes the device from the pocket into the hand. A momentary acceleration associated with the user's reaction can be ignored. The mechanical vibration caused by the movement of the car can also be seen in the device in a different manner in the hand than what the vibration looked like when the device was in the pocket.

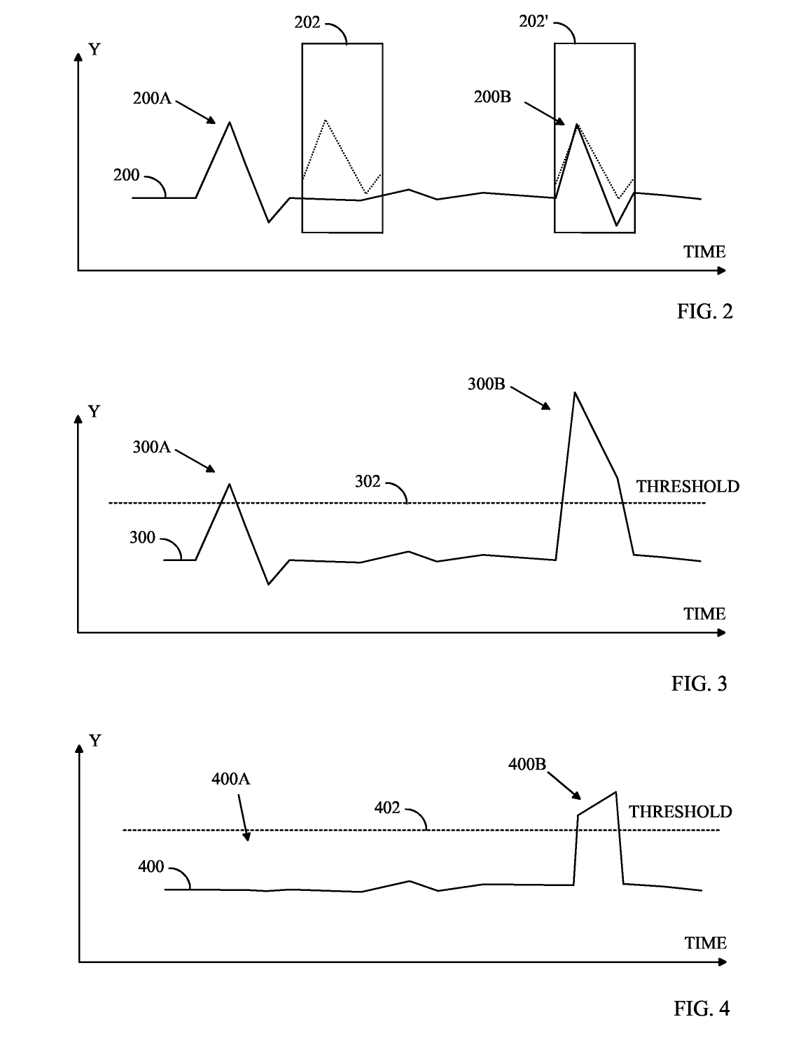

FIGS. 2, 3 and 4 illustrate the identification steps of the motion pattern and the gesture described in connection with FIG. 1. For the sake of simplicity, said figures show a signal 200, 300, 400 to be measured, as a uniplanar Y signal component, but in practice the signal to be measured/compared may also be a sum vector composed of several components. In the example shown in FIG. 2, a person can be thought to be walking, whereby a periodically recurring motion pattern is formed in the Y signal component 200 and includes signal peaks 200A and 200B. A motion pattern 202, descriptive of a person's walk, has been stored in the device or taught to the device in advance. The motion pattern 202 is slid on the time axis over the signal 200 measured and at point 202′, the data stored in the motion pattern 202 and the signal peak 200B measured are observed to be congruent enough in order for the signal 200 measured to be interpreted, in the device, to represent a person's walk. It is evident that at the initial moment of the measurement, the device does not necessarily know that a person is walking, for which reason the measured signal may have to be compared in the device with several motion patterns descriptive of different operating situations.

FIG. 3 illustrates an error identification problem in an electronic device employing motion identification. The assumption is that a threshold value 302 is specified in the device, and a signal whose amplitude in the device exceeds said value is interpreted as a gesture that initiates a predetermined function in the device. In the case of FIG. 3, a signal peak 300A caused by walking would be erroneously interpreted as a gesture initiating a function. However, the gesture the user means is executed only at point 300B of the signal to be measured, at which point the gesture meant by the user is summed to the walking signal peak.

FIG. 4 shows a signal according to FIG. 3, from which the recurring motion pattern caused by walking is filtered off. Signal peak 400B, exceeding a threshold value 402 and descriptive of an actual gesture performed by the user is easily detectable in a remaining measured signal 400.

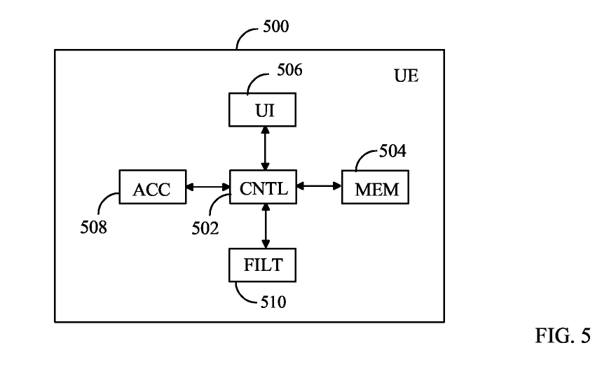

FIG. 5 shows an electronic device 500 according to an embodiment. The device 500 comprises a control unit 502 that can be implemented by software in a general-purpose processor, for example. The task of the control unit is to coordinate the operation of the device. For example, the control unit 502 communicates with a memory unit 504 in the device. Motion patterns and/or gestures, for example, can be either stored in the memory as a factory setting or taught by the user. The device may also comprise a user interface 506. For example, in the case of a mobile telephone, the user interface may comprise a keyboard, a display, a microphone and a loudspeaker. The keyboard and the display can be used to control the operation of the device by means of menus, for example. In a mobile telephone, a given gesture can be taught for instance by the user selecting a teaching function from a menu by means of a keyboard and a display, and selecting the starting and end times of the teaching by means of the keyboard. Naturally, the device may be controlled not only with the keyboard, but also by means of voice or gestures, for example.

The electronic device according to FIG. 5 also comprises an acceleration measurement unit 508, which can be implemented by means of one or more linear acceleration sensors and/or one or more angular acceleration sensors, for example. Furthermore, the device may comprise an identification unit 510, which aims at identifying a given motion pattern in the data measured by the measurement unit 508. The identification unit may aim at identifying the motion pattern either by comparing the data measured with a reference pattern stored in the memory 504 or by aiming at identifying the motion pattern by means of a previously stored reference pattern.

Furthermore, the identification unit 510 may compare the motion information measured by the measurement unit with the control motions, such as gestures, stored in the memory. The identification unit may eliminate the effect of an identified motion pattern from the control motion, thus promoting the identification of the control motion.

The invention is implementable in an electronic device by software storable in a processor, for example. In this case, the software includes one or more software routines for executing the method steps of the method according to the invention. The invention is also implementable with an application-specific integrated circuit (ASIC) or with separate logics components.

It is obvious to a person skilled in the art that, as technology advances, the basic idea of the invention can be implemented in a variety of ways. Consequently, the invention and its embodiments are not restricted to the above examples, but can vary within the scope of the claims.

1. A method of controlling an electronic device, comprising:
identifying a motion pattern in the motion of the device; and
eliminating the effect of the identified motion pattern from a control motion used for controlling the device.

2. A method as claimed in claim 1, wherein the motion pattern identified in the motion of the device is a recurring motion pattern.

3. A method as claimed in claim 1, wherein the motion pattern is identified before the start of the control motion.

4. A method as claimed in claim 1, wherein:
a motion pattern detected before the start of the control motion and a motion pattern during the control motion are identified in the device;
only the motion pattern detected before the start of the control motion is eliminated from the control motion.

5. A method as claimed in claim 1, wherein:
in a device-originating event, a predetermined period of time is allowed to pass before information about the event is given to a user of the device;
the motion pattern is identified during said period of time.

6. A method as claimed in claim 1, wherein:
in a user-originating event, an initiation impulse indicative of the start of the use of the device is received from a user;
the motion pattern is identified after reception of the initiation impulse.

7. A method as claimed in claim 1, wherein:
the motion of the device is measured by means of one or more motion parameters.

8. A method as claimed in claim 7, wherein:
one or more motion parameters measured are compared with a reference motion pattern stored in advance in the device;
the reference motion pattern is accepted as identified when the comparison between one or more motion parameters measured and the reference motion pattern fulfils a predetermined threshold condition.

9. A method as claimed in claim 7, wherein:
an autocorrelation function is generated from the values of one or more motion parameters measured;
a recurring motion pattern is identified from the autocorrelation function generated.

10. A method as claimed in claim 7, wherein:
the one or more motion parameters measured are compared with a control motion pattern stored in the device in advance;
the control motion is accepted as identified when the comparison between one or more motion parameters measured and the control motion pattern fulfils a predetermined threshold condition.

11. A method as claimed in claim 1, wherein the electronic device is a mobile telephone.

12. A method as claimed in claim 2, wherein
the recurring motion pattern is mechanical vibration.

13. A software product, wherein the software product comprises:
a software routine for receiving measurement information descriptive of a motion of the device,
a software routine for identifying a motion pattern in the measurement information, and
a software routine for eliminating the effect of the motion pattern from a control motion used for controlling the device and included in the measurement information.

14. An electronic device, wherein the device comprises:
means for identifying a motion pattern in a motion of the device; and
means for eliminating the effect of the motion pattern from a control motion used for controlling the device.

15. A device as claimed in claim 14, wherein the motion pattern to be identified is a recurring motion pattern.

16. A device as claimed in claim 14, wherein the identification means are configured to identify the motion pattern before the start of the control motion.

17. A device as claimed in claim 14, wherein:
the identification means are configured to identify a motion pattern detected before the start of the control motion and a motion pattern during the control motion; and
the elimination means are configured to eliminate only the motion pattern detected before the start of the control motion from the control motion.

18. A device as claimed in claim 14, comprising:
means for detecting the start of a device-originating event;
means to wait a predetermined period of time before a user of the device is given information about the event; and
the identification means are configured to identify the motion pattern during said period of time.

19. A device as claimed in claim 14, comprising:
means for receiving an initiation impulse indicative of the start of the use from a user of the device; and
the identification means are configured to identify the motion pattern after reception of the initiation impulse.

20. A device as claimed in claim 14, comprising:
means for measuring the motion of the device by means of one or more motion parameters.

21. A device as claimed in claim 20, the identification means being configured to:
compare one or more motion parameters measured with a reference motion pattern stored in advance in the device;
accept the reference motion pattern as identified when the comparison between one or more motion parameters measured and the reference motion pattern fulfils a predetermined threshold condition.

22. A device as claimed in claim 20, wherein the identification means are configured to:
generate an autocorrelation function from the values of one or more motion parameters measured; and
identify a recurring motion pattern from the autocorrelation function generated.

23. A device as claimed in claim 20, comprising:
means for comparing one or more motion parameters measured with a control motion pattern stored in advance in the device;
means for accepting the control motion as identified when the comparison between one or more motion parameters measured and the control motion pattern fulfils a predetermined threshold condition.

24. A device as claimed in claim 14, the electronic device being a mobile telephone.
